(19) United States
(12) Patent Application Publication
(10) Pub. No.: US 2016/0144834 A1
(43) Pub. Date: May 26, 2016

(54) ICE SCRAPER AND METHOD OF USE

(71) Applicant: Charles E. Bryant, II, Blue Springs, MO (US)

(72) Inventor: Charles E. Bryant, II, Blue Springs, MO (US)

(21) Appl. No.: 14/555,152

(22) Filed: Nov. 26, 2014

(51) Int. Cl. B60S 3/04

(52) U.S. Cl. CPC B60S 3/045

(57) ABSTRACT

An ergonomic ice scraper includes a handle with a contact surface at one end and a scraping blade at an opposite end. The blade includes a scraping edge formed by intersection of a scraping surface with a base surface at an angle such that when the contact surface and the scraping edge are placed in contact with a coated surface to be scraped, the scraping surface is oriented at substantially a right angle to the coated surface. The blade may include a pair of scraping edges at opposite ends thereof and be rotatably mounted in the handle in such a manner as to enable positioning a selected scraping edge in a scraping position relative to the handle.

### BACKGROUND OF THE INVENTION

The present invention is directed toward an ergonomic device for removing materials or substances from a coated surface, more particularly for scraping ice, frost, slush or other frozen matter off of glass surfaces or panes, such as a windshield or window of a car, truck or other such vehicle.

Ice scrapers are well known and commonly used to remove material, such as ice, slush and frost, that has accumulated on vehicle windows during winter weather. Ice scrapers usually include a type of chisel-like blade structure attached to a handle. Generally, the operator uses the handle to impact the blade on the ice, so as to provide a sufficient force to break up the ice and then to push and scrape the ice from the window. Scraping ice from windows is known to cause stress and strain on an operator's limbs, such as the hand, wrist, arm, shoulder and back. As a result of this stress and strain, some operators experience substantial levels of pain as a result of scraping ice from their vehicle's windows.

Since this activity is usually performed outside in freezing weather and can cause pain to the operator, it is desirable to spend as little time doing it as possible. Therefore, there is a need for an ice scraper device that enables the operator to quickly and efficiently perform the ice scraping task while simultaneously preventing undue stress and strain operator's body while the task is being performed.

### SUMMARY OF THE INVENTION

The present invention is directed toward an ergonomically shaped ice scraping device or scraper, for the effective removal of ice, frost or other frozen matter from a curved surface, such as an automobile window or pane, without the application of substantial stress or strain to the operator's body. The ice scraping device may be a two part device with a movable blade joined with a handle. The blade includes a scraping structure and may include two or more selectable chisel-like scraping structures for breaking and scraping the ice. The handle is ergonomic and sized and shaped such that when it is gripped by the user and the handle rear end is placed against the windshield, the blade is automatically positioned for optimal scraping efficiency and thereby to prevent wear and tear on the operator's hand and arm.

In an embodiment of the invention, the blade includes two interchangeable scraping structures or edges that are sized and shaped to provide different amounts of scraping pressure on the ice for a given amount of force to the handle applied by the operator. In one aspect of the scraper, a first of the interchangeable scraping structures includes an edge with a first width so as to provide a first scraping pressure during use of the device. In a further aspect of the scraper, a second of the interchangeable scraping structures includes a reduced width so as to provide a second scraping pressure during use of the device, wherein the second scraping pressure is substantially greater than the first scraping pressure. Since it is greater, the second scraping pressure may be used to break and remove harder or thicker ice from the windshield than can the first scraping force.

In another embodiment, the blade is rotatable relative to the handle, thereby enabling selecting and engaging the desired scraping structures. In one aspect, the blade includes an elongate slot that cooperates with the handle to provide blade clearance while selecting and engaging the scraping structures. In a further aspect, the blade is slidable and rotatable along the length of the slot with respect to the handle. In another aspect, each scraping structure includes a locking slot that cooperates with the handle to lock a selected scraping structure in place for device operation. The scraping edges may be located at opposite ends of the blade.

In yet another embodiment, during operation of the device, the operator presses the handle rear end and the selected scraping structure toward the windshield, and then pushes the device forward, such that ice on the windshield is engaged by the scraping structure. In an aspect, the scraping structure may be shaped such that then the handle rear end engages the windshield surface, a forward surface of the scraping structure and the windshield define an angle that is substantially 90°, such as to optimize the scraping force applied to the ice.

In still another embodiment, the handle is ergonomically shaped so as to minimize stress on the operator's body during use of the device. In an aspect, the handle is decoratively shaped, so that the device appearance is entertaining. For example, handle can be shaped so that the device is reminiscent of a motorcycle, a duck, a fish, or the like. Decorative features, such as miniature handle-bars and decals, can be applied to the handle. In some circumstances, such decorative features can be movable or provide sound.

While the present invention has particular applicability to scraping ice or frost from automobile windows, it is foreseen that embodiments of the scraper could be implemented for scraping other types of materials from surfaces other than windows.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of a device for scraping a material off of a surface, in a first embodiment in accordance with the invention.

FIG. 2 is a side elevation view of the device of FIG. 1.

FIG. 3 is a top plan view of the device of FIG. 1.

FIG. 4 is a front elevation view of the device of FIG. 1.

FIG. 5 is a bottom plan view of the device of FIG. 1.

FIG. 6 is a rear elevation view of the device of FIG. 1.

FIG. 7 is an enlarged fragmentary top plan view of the device of FIG. 1, with portions shown in phantom to show greater detail thereof.

FIG. 8 is an enlarged fragmentary cross-sectional view of the device of FIG. 7, the cross-section being taken along lines 8-8 of FIG. 7.

FIGS. 9 and 11-13 are enlarged fragmentary top plan views of the device of FIG. 1, with portions shown in phantom to show greater detail thereof and showing intermediate positions of the blade of the device during reversal thereof.

FIG. 10 is an enlarged fragmentary cross-sectional view of the device of FIG. 9, the cross-section being taken along lines 10-10 of FIG. 9.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

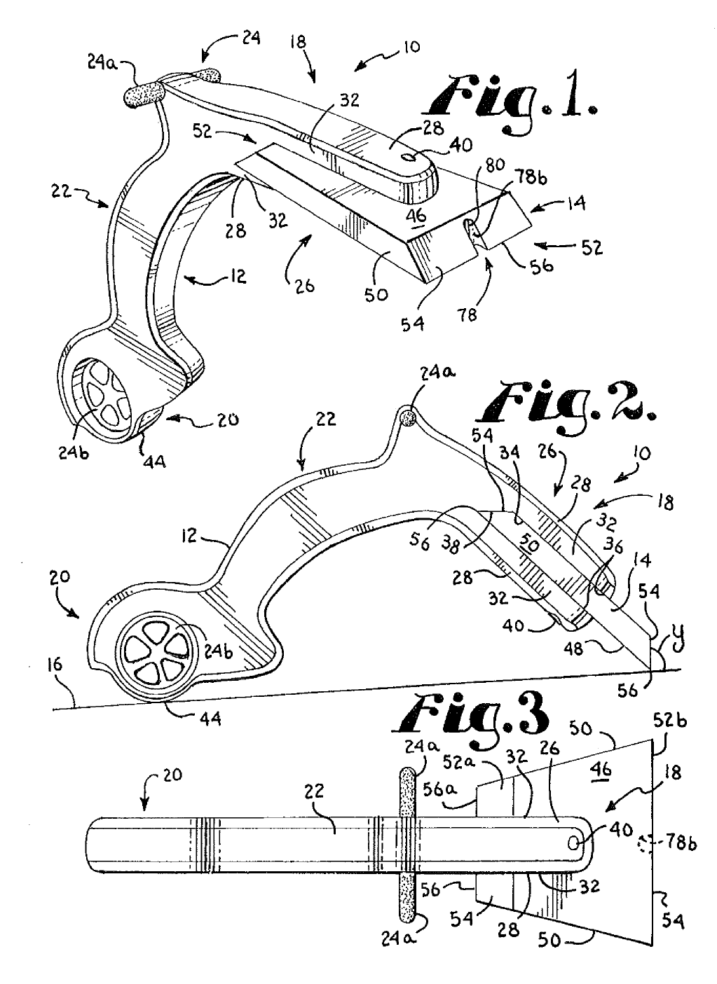

In FIGS. 1 through 13 an ice scraper of the illustrated embodiment is generally denoted by the numeral 10. The ice scraper 10 includes a scraper body or handle 12 joined with a positionable scraper blade 14. During use, an operator (not shown) holds the scraper 10 by the handle 12 so that the handle 12 and the blade 14 both contact a surface 16 (see FIG. 2). It is known that pressure (p) and force (F) are related to one another according to the formula p=F/A, wherein A is the area of the surface on contact. Accordingly, when the operator uses the handle 12 to press or push the scraper 10 toward the surface 16, he or she applies force to the scraper 10 and thereby creates a scraping pressure directed toward the surface 16 and material (not shown) adhered thereto, which may be referred to herein as a scraping action.

The scraper handle 12 includes a front end, generally 18, and a rear end, generally 20, joined together by an ergonomic grip portion or grip, generally 22. The handle 12 can be formed of a variety of rigid materials such as polymers, metals, wood and combinations thereof.

In addition to being shaped to perform a scraping action or function, such as to reduce stress and strain on the operator, the handle 12 can be decoratively shaped and include decorative structures or decorative features, generally 24, such as stylized motorcycle handle bars 24a, a stylized motorcycle wheel 24b, or the like. A variety of other decorative features 24 are foreseen, which can incorporate functional structures of the ice scraper 10 and additionally or alternatively can be merely decorative structures, images and the like.

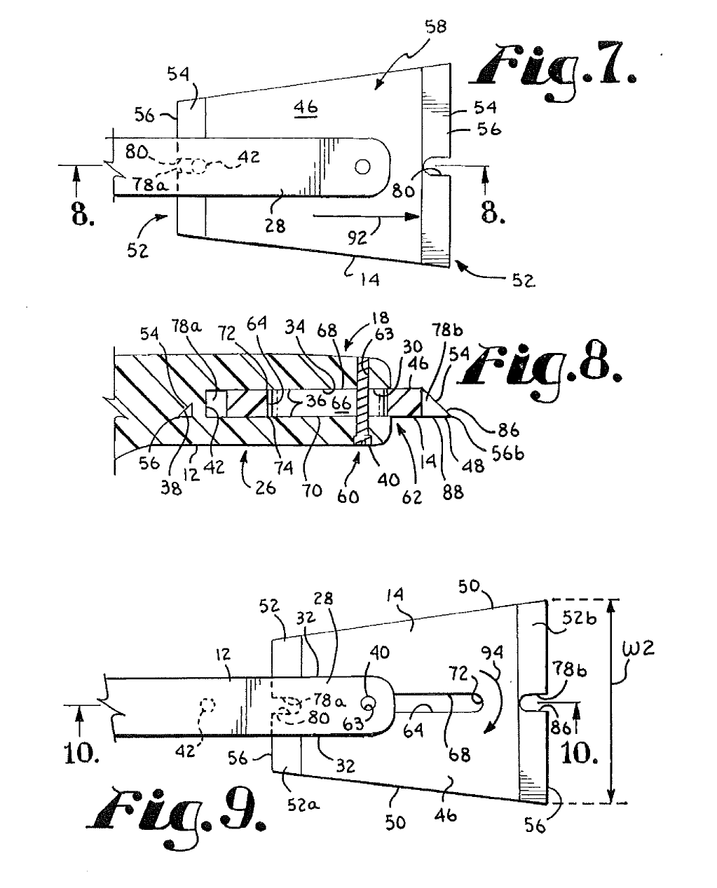

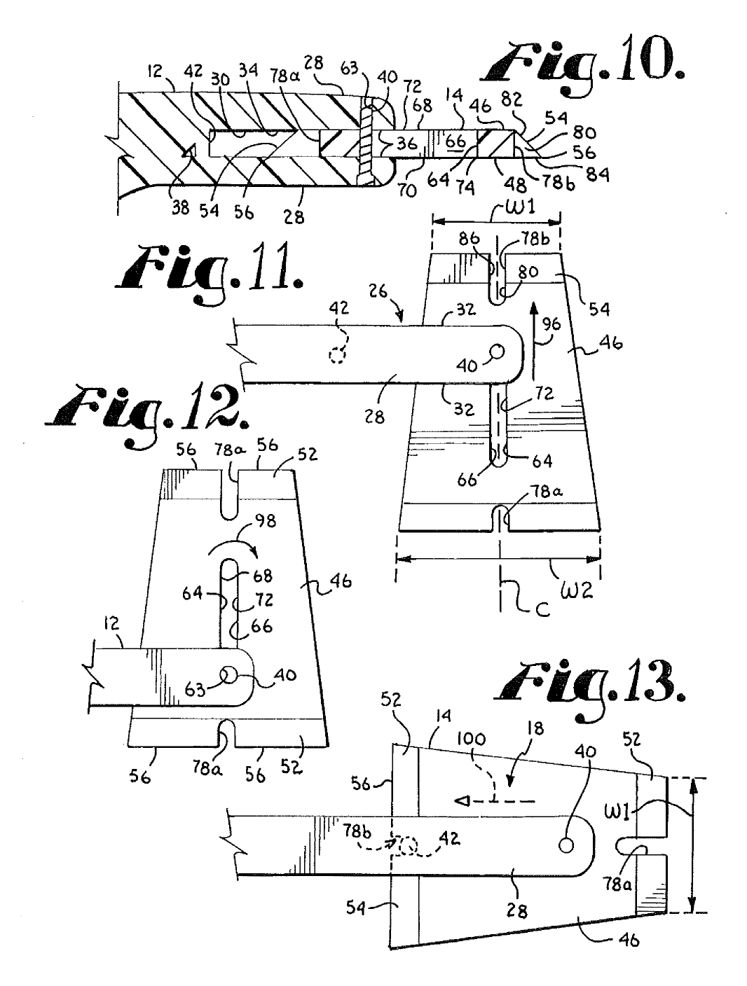

The handle front end 18 includes a blade attachment structure, generally 26, for attaching the blade 14 to the handle 12 and for positioning the blade 14 for scraping. In the illustrated embodiment, when viewed from the side (see FIG. 2) the blade attachment structure 26 is generally U-shaped or V-shaped, with a pair of forward-extending arms 28 that run parallel with one another and define an elongate through-slot 30 (FIG. 10). The through-slot 30 is sized and shaped to receive a portion of the blade 14 therein. Accordingly, the through-slot 30 extends laterally through the front end 18 (FIGS. 3-6) so as to provide clearance for the blade 14 during positioning (described below) and so as to allow portions for the blade 14 to extend outwardly from the sides 32 of the front end 18. The through-slot 30 includes a plurality of surfaces 34 that are complementary to the blade 14. For example, the through-slot 30 includes upper and lower surfaces 36 (FIG. 2), which slidingly engage the blade 14, and an abutment surface 38 which abuts the blade 14 when the blade 14 is positioned for scraping the surface 16. The blade 14 is received between the arms 28 such that it slidingly engages the through-slot upper and lower surfaces 36. The blade attachment structure 26 also includes a blade rotation axle 40 and a blade stop structure or stop 42 (FIG. 7), which are described in greater detail below with respect to the blade 14.

The handle 12 includes a positioning arrangement or configuration, wherein the grip 22 is sized and shaped to provide a bridge between the front and rear ends 18 and 20, respectively, and to thereby guide proper placement of the blade 14 on the surface 16. In particular, as shown in FIG. 2, the handle rear end 20 includes a window-engaging heel or contactor, generally 44 that is located such that, when the scraper 10 is correctly placed against or on the surface 16, the contactor 44 and the blade 14 both touch or engage the surface 16. This positioning arrangement correctly positions the blade 14 for efficient material removal by the scraping action while simultaneously preventing substantial stress or strain on the operator. This is described in greater detail below with respect to the blade 14.

The multi-sided scraper blade 14 is received in the blade attachment structure 26 so as to be positionable. The blade 14 is fabricated from a rugged polymer that substantially withstands repeated impacts, blows, banging or scraping against hard materials such as ice, frost, glass and metal, at freezing temperatures, without significant or substantially breaking or chipping.

In the illustrated embodiment, the illustrated blade 14 is substantially planar with trapezoidal upper and lower sides 46 and 48 (FIG. 10), respectively, and a longitudinal axis C (FIG. 11). The trapezoidal upper and lower sides 46, 48 are planar and spaced apart and parallel with each other. The upper and lower sides 46, 48 are joined together by a pair of spaced apart outer sides 50 and by at least two spaced apart scraping structures, generally 52. The upper and lower sides 46 and 48 are spaced apart such that the blade 14 has a thickness complementary to the through-slot 30 of the blade attachment structure 26. Accordingly, the blade upper and lower sides 46 and 48 slidingly engage the upper and lower surfaces 36 of the arms 28. These complementary surfaces and sides 36, 46, 48 enable the blade 14 to be rotated in the blade attachment structure 26, such as is described below with respect to FIGS. 7-13. It is foreseen that the blade 14 may have other shapes that are complementary to the blade attachment structure 26.

The blade 14 includes a plurality of scraping structures 52 that are spaced apart from each other. In the illustrated embodiment, the blade 14 includes two scraping structures 52 that are positioned or oriented so as to be generally parallel with each other. The scraping structures 52 are spaced apart a distance that is sufficient to provide clearance when switching between scraping structures 52, as described below, and such that the ergonomic positioning of the operator's hand is substantially maintained when scraping 16. It is foreseen that, in other embodiments, the blade 14 may include more than two scraping structures 52 that are sufficiently spaced apart to both enable blade clearance and to maintain the aforementioned ergonomics when in use.

Each selectable scraping structure 52 includes a leading side or leading surface 54 that intersects or joins with the blade lower or base side 48 so as to provide a scraping edge 56. The leading surface 54 is slanted relative to the upper and lower sides 46, 48 to form a bevel such that when the scraping edge 56 and the contactor 44 both engage the surface 16, the surface 16 and the leading surface 54 define substantially a 90° angle denoted by the arc Y, which is most easily seen in FIG. 2. During use, when the scraper 10 is moved forward on the surface 16 by the operator, both the contactor 44 and the scraping edge 56 remain engaged with the surface 16, whereby the 90° angle is substantially maintained.

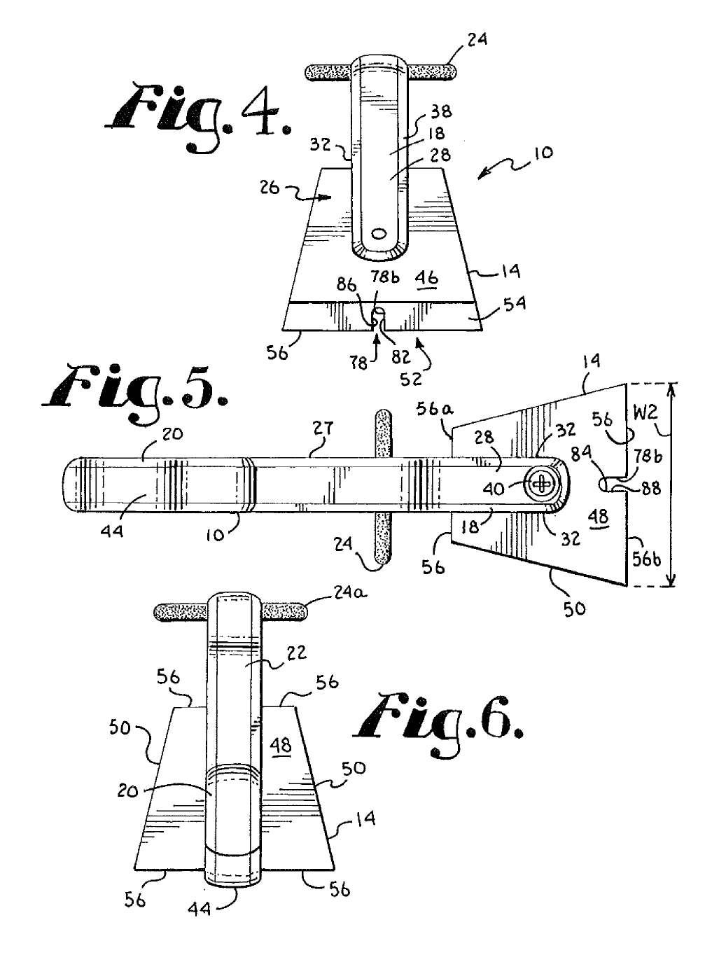

A first of the scraping structures, denoted by 52a (FIG. 9), has a first scraping edge 56a (FIG. 5), which includes a first width W1 (see FIGS. 11 and 13). A second of the scraping structures, denoted by 52b (FIG. 9), has a second scraping edge 56b (FIG. 8), which includes a second width W2 (see FIGS. 9 and 11). Since W1 is less than W2, the first scraping structure 52a applies greater force to the surface 16 than does the second scraping structure 52b. Since, for a given amount of force F applied by the operator, the first scraping structure 52a applies a greater amount of pressure p to the surface than does the second scraping structure 52b, giving the negligible surface area of the blade edges 56a and 56b. This greater amount of pressure p exerted by the first scraping structure 52a enables the operator to more easily break up and scrape material from the surface 16 than is possible with the second scraping structure 52b. For example, for a given amount of pressure, the operator can scraper away thicker ice using the first scraping structure 52a (i.e., the narrower scraping structure 52) than he/she can scrape away with the second scraping structure 52b (i.e., the wider scraping structure 52). Having two different sized scraping structures 52 provides the operator with a range of scraping capabilities and enables the operator to remove different types of materials from the surface 16. For example, the operator could remove heavy, thick ice using the first scraping edge 56a and then remove thin, breakable sheets of ice using the second scraping edge 56b. Numerous variations of scraping structures 52 are foreseen.

As noted above, the scraping structures 52 are selectable, so as to provide a range of scraping actions. For example, in the illustrated embodiment, the blade 14 is sized and shaped to reversibly rotate an amount of at least 180° with respect to the handle front end 18, so that each of the first and second scraping structures 52a or 52b can be selectively positioned for scraping the surface 16. In some embodiments, the blade 14 may be sized and shaped to reversibly rotate 360° with respect to the handle front end 16. Numerous alternative mechanisms of scraping structure selection are foreseen.

In order to provide for rotation of the blade 14, the scraper 10 includes a two-part rotation mechanism 58 (FIG. 7), wherein a first part, generally 60 (FIG. 8), of the rotation mechanism 58 is provided by the handle 12 and a second part, generally 62 (FIG. 8), of the rotation mechanism 58 is provided by the blade 14. The rotation mechanism first and second parts 60, 62, respectively, cooperate to enable selection between the scraping structures 52a, 52b and positioning of the blade 14.

The rotation mechanism first part 60 includes the handle front end 18, more particularly the blade attachment structure 26. In the illustrated embodiment, the blade attachment structure 26 includes the through-slot 30 that slidingly receives the blade 14 therein, the axle 40 about which the blade 14 rotates, and the stop 42 that cooperates with a non-selected scraping structure 52 to lock to blade 14 into position for use of the selected or opposed scraping structure 52, such as is described below.

The axle 40 may be a screw, rod, pin or other axle-like structure known in the art, which is received through bores 63 in the handle arms 28 near the arm forward ends (see FIGS. 8 and 11). The axle 40 is sized and shaped to receive the blade 14 thereon or thereabout and cooperates with the rotation mechanism second part 62 so as to enable the blade 14 to reversibly slide, pivot and rotate thereabout. It is foreseen that the axle 40 may be any similar such structure known in the art that performs the aforementioned cooperative pivoting function.

The blade stop 42 may be a structure formed by a pin, peg or detent that extends between the arms 28 in the through-slot 30 and is located adjacent to the grip 22 of the handle 12. The stop 42 is sized and shaped to cooperate with the blade 14, so as to lock the blade 14 into place for scraping the surface 16. In some embodiments, the stop 42 may be integral with the handle 12, such as by being machined into the handle material at the time the arms 28 are formed. In other embodiments, the stop 42 may be a separate rod, pin or screw that is inserted between the arms 28, such as is understood by one skilled in the art. Alternative stop structures are foreseen.

The rotation mechanism second part 62 includes components of the blade 14 that cooperate with the first part 60. In the illustrated embodiment, the blade 14 includes a longitudinal axis C (see FIG. 11) that is perpendicular to the first and second scraping edges 56a, 56b and divides the blade 14 into two lateral portions that are mirror images of each other. An elongate blade rotation slot 64 extends through the thickness of the blade 14 and runs a length of the blade 14 so as to be parallel with the longitudinal axis C. The rotation slot 64 is sized to receive the rotation axle 40 therethrough, so that an axle outer surface 76 (FIG. 10) slidingly engages the inner surface 66. The axle outer surface 76 and the rotation through-bore inner surface 66 cooperate to guide rotation of the blade 14 and thus selection between the first and second scraping structures 52a and 52b.

The rotation mechanism second part 62 includes a pair of scraping structure selection notches, generally 78 (FIG. 1), that are in-line with the rotation slot 64 and parallel with the axis C. In the illustrated embodiment, the first scraping structure 52a includes a first selection notch 78a and the second scraping structure 52b includes a second selection notch 78b. The selection notches 78 extend inwardly from the associated scraping edges 56 and run parallel with the longitudinal axis C. In the illustrated embodiment, the selection notches 78 are located so as to bisect the associated scraping edges 56, such that the scraping edges 56 are discontinuous.

Each selection notch 78 includes an inner wall 80 with an upper opening 82 and a lower opening 84. The upper opening 82 includes an upper edge 86 that joins the inner wall 80 with at least the associated leading surface 58 and optionally with the blade upper side 46. For example, as shown in FIG. 11, the first notch 78a extends toward the second scraping structure 52b, with an upper edge 86 that joins the inner wall 80 with both the leading surface 54, of the first scraping structure 52a, and the upper side 46. In contrast, the second notch 78b, extends toward the first scraping structure 52a, and includes an upper edge 86 that joins the associated inner wall 80 with the associated leading surface 54, but not with the upper side 46. Each of the notches 78 includes a lower opening 84 with a lower edge 88 that joins the inner wall 80 with the lower side 48.

The selection notches 78 are sized and shaped to reversibly engage and cooperate with the blade stop 42. Accordingly, the inner walls 80 are reversibly slidingly engageable with an outer surface 90 of the blade stop 42. The inner walls 80 are complementary in shape to the stop 42.

During use, the operator selects one of the scraping structures 52 in the blade attachment structure 26, positions or places the scraper 10 on the surface 16 and then scrapes the surface 16 by pushing the scraper 10 forward on the surface 16. FIGS. 7 through 13 illustrate selecting the first scraping structure 52a and positioning the first scraping structure 52a for scraping the surface 16, in one embodiment.

With reference to FIGS. 7 and 8 and prior to a first step of selecting the first scraping structure 52a, the blade 14 is positioned in the handle 12 so that the second scraping structure 52b is ready for use. In particular, the second scraping structure 52b extends toward the right of the page and the first selection notch 78a (in phantom) is engaged with the stop 42 (in phantom). As is most easily seen in FIG. 8, the rotation axle 40 is a screw the extends vertically (relative to FIG. 8) from the lower arm 28, through the blade rotation slot 64 and then through the upper arm 28.

In the first step of selecting the first scraping structure 52a, the blade 14 is pulled outwardly from the handle 12, especially from the blade attachment structure 26. This movement is illustrated by the straight arrow denoted by the numeral 92 (see FIG. 7). At the completion of the first step, the blade 14 is positioned such as is shown in FIGS. 9 and 10. In particular, the left-hand side of the rotation slot 64 engages the axle 40, such that the surfaces thereof 66 and 76, respectively, are engaged. When the blade 14 is in this illustrated position, the first selection notch 78a is disengaged from the blade stop 42.

In a second step of selecting the first scraping structure 52a, the illustrated blade 14 is rotated clockwise about 90° relative to the longitudinal axis C. For example, in FIG. 9, the blade 14 is to be rotated toward the bottom of the page, as shown by the curved arrow denoted by the numeral 94, until the blade 14 is positioned as is illustrated in FIG. 11. When the blade 14 is correctly positioned, the longitudinal axis C is substantially perpendicular to the through-slot 30 located between the arms 28. Additionally, the first and second scraping edges 56a and 56b are parallel with the arms 28.

In a third step of selecting the first scraping structure 52a, the blade 14 is pushed (or pulled) upwardly (relative to the page) as illustrated by the upwardly-pointing straight arrow denoted by the numeral 96 (see FIG. 11). It is foreseen that the operator could rotate the blade 14 in the counterclockwise direction opposite to that illustrated by arrow 94, so that instead of pushing the blade 14 upward the user would pull the blade 14 downward, in the direction opposite to that illustrated by arrow 96. Once the blade 14 has been pushed upward, such as is illustrated by arrow 96, the blade 14 is positioned as is shown in FIG. 12. When in this position, the end of the rotation slot 64, which is adjacent to the second scraping structure 52b, is slidingly engaged with the axle 40.

In a fourth step of selecting the first scraping structure 52a, the blade 14 is again to be pivoted clockwise about 90° on the axle 40, such as is illustrated by the arrow denoted by the numeral 98. When this second rotation is completed, the blade 14 is positioned and aligned for being pushed back into the blade attachment structure 26 (not shown).

In a final step of selecting the first scraping structure 52a, the blade 14 is pushed into the blade attachment structure 26, such as illustrated by the phantom arrow 100 of FIG. 13 thereby locking the blade 14. When the blade 14 is locked and positioned for scraping the surface 16 with the first scraping structure 52a, the second selection notch 78b is engaged with the stop 40 and the second scraping structure 52b is adjacent to the handle grip 22. Once the first scraping structure 52a is positioned and the blade 14 is substantially fixed in place, locked and non-rotatable by the cooperation of the stop 40 and the second selection notch 78b are engaged such that the notch inner surface 80 and the stop outer surface 90 are engaged.

It is noted that the blade 14 and the blade attachment structure 26 are sized and shaped so that the aforementioned procedure can be performed in reverse, to move the second scraping structure 52b back into position for scraping the surface 16. Additionally, the blade movements illustrated by the arrows 92, 94, 96, 98 and 100 are reversible.

Once the blade 14 is positioned for scraping the surface 16 with the first scraping structure 52a, the operator places the scraper 10 on the surface 16 such that the surface 16 is simultaneously engaged by the first scraping structure 52a and the device rear end 20. In particular, both the handle contactor 44 and the first scraping edge 56a contact the surface 16. Additionally, the first leading surface 54 forms a substantially 90° angle with the surface 16, wherein the angle is similar to the angle defined by the arc Y shown in FIG. 2. When positioned on the surface 16 and viewed from the side 32, the scraper 10 will appear substantially as is shown in FIG. 2.

In a final step of operation, the operator pushes the scraper 10 forward on the surface 16 so that the contactor 44 and the scraping edge 56a remain in contact with the surface 16 and material on the surface 16 is scraped away. The operator periodically picks up the scraper 10 and moves it to an un-scraped portion of the surface 16, and repeats the scraping motions.

As noted above, the scraper 10 is sized and shaped such that during use, as described herein, the operator experiences reduced stress and strain on his limbs. As is known in the art, the total amount of stress and strain experienced by the operator depends upon a variety of factors, such as the thickness or hardness of the frozen material, the operator's height and physical condition, the amount of pressure exerted by the operator, the window's size, shape and height, and the size and shape of the ice scraper.

It is to be understood that while certain forms of the present invention have been illustrated and described herein, it is not to be limited to the specific forms or arrangement of parts described and shown.

What is claimed and desired to be secured by Letters Patent is as follows:

1. A device for removing a material from a coated surface, comprising:
a) a scraper body having a front end with a blade attachment structure, a rear end with a coated surface-engaging portion, and an ergonomic grip portion joining the front and rear ends; and
b) a positionable scraper blade received in the blade attachment structure, the blade having a plurality of selectable scraping structures that are sized and shaped for applying an amount of a scraping pressure to the coated surface; wherein
c) when in use, the rear end coated surface-engaging portion contacts the surface and the selected and positioned scraping structure slidingly engages the surface so as to apply the associated scraping pressure to the material while substantially preventing operator bodily stress.

2. The device according to claim 1, wherein:
a) each scraping structure has a scraping edge formed by a leading surface; and
b) the scraper body is shaped in such a manner that when the rear end and the scraping edge are positioned in contact with the coated surface the leading surface is oriented at about a 90° angle relative to the coated surface.

3. The device according to claim 1, wherein:
a) a first of the selectable scraping structures includes a first width; and
b) a second of the selectable scraping structures includes a second width that is greater than the first width; wherein
c) the amount of the scraping pressure associated with each of the first and second widths is inversely proportional to the width.

4. The device according to claim 1, wherein:
a) the blade is multi-sided.

5. The device according to claim 1, wherein:
a) the blade is sized and shaped to reversibly rotate about an angle of at least 180° with respect to the handle front end.

6. The device according to claim 5, wherein:
a) the blade is sized and shaped to reversibly rotate 360° with respect to the handle front end.

7. The device according to claim 1, wherein:
a) the grip is sized and shaped as a bridge between the front and rear ends.

8. The device according to claim 1, wherein:
a) the plurality of selectable scraping structures includes a first scraping structure with a first width, and a second scraping structure with a second width that is greater than the first width; and
b) the first position member includes an elongate slot running perpendicular to the first and second scraping structures, the slot being sized and shaped so as to receive therethrough a spindle of the second position member; wherein
c) the spindle is movable in the through-slot so as to rotate the blade and position the selected scraping structures for use.

9. The device according to claim 1, wherein:
a) the blade is trapezoidal.

10. The device according to claim 1, wherein:
a) the scraper body front end includes an elongate connection slot sized and shaped to receive the blade therein; and
b) the first and second position members cooperate with the connection slot to provide sufficient clearance for the blade to rotate at least 180° during selection and positioning of a scraper structure for use.

11. A method of removing a frozen material from a surface of a vehicle window pane, comprising:
a) selecting a scraping structure of a scraping device with a scraper blade having a pair of spaced apart and parallel scraping structures, wherein a first of the scraping structures includes a first length and a second of the scraping structures includes a second length that is greater than the first length;
b) simultaneously engaging the window surface with the selected scraping structure and with a rear end of the scraping device;
c) applying a force toward the window surface; and
d) engaging the frozen material on the window surface to remove it therefrom.

12. The method according to claim 11, wherein:
a. the step of selecting a scraping structure includes rotating the scraper blade an amount of at least 180°.

13. A scraper device for removing material from a coated surface and comprising:
a) a handle for gripping the device and having opposite ends and a surface contact at one end;
b) a scraping blade extending from an end opposite the contact surface, the blade having a scraping edge formed by intersection of a base surface with a scraping surface; and
c) the handle and the blade being spatially interrelated in such a manner that, when the surface contact and the edge are positioned in contact with the coated surface, the scraping surface is oriented at substantially a right angle to the coated surface.

14. A device as set forth in claim 13 wherein:
a) the blade has multiple scraping edges; and
b) the blade is movably mounted on the handle to enable selection of a desired scraping edge.

15. A device as set forth in claim 14 wherein:
a) the scraping edges are unequal in length.

16. A device as set forth in claim 14 wherein:
a) the blade has a substantially trapezoidal shape.

17. A device as set forth in claim 13 wherein:
a) the blade has opposite ends, each of the ends having a respective scraping edge formed thereon by an associated scraping surface;
b) the blade is rotatably mounted on the handle to enable releasably fixing a selected scraping edge in a scraping position relative to the handle; and
c) each scraping surface is angled in such a manner that when the contact surface and a selected scraping edge are positioned in contact with the coated surface, the scraping surface of the selected scraping edge is oriented at substantially a right angle to the coated surface.

18. A device as set forth in claim 13 wherein:
a) the handle has a pair of spaced apart arms extend from the end opposite the contact surface;
b) the blade has opposite blade ends, the blade ends having respective scraping edges formed thereon by associated scraping surfaces, the scraping edges being substantially parallel;
c) the blade has an elongated slot formed therethrough which extends between the blade ends in substantially perpendicular relation thereto;
d) the blade is positioned between the spaced apart arms with a pin-like structure extending through the slot; and
e) the slot facilitates rotation of the blade about the pin-like structure to position a selected scraping edge in a position to scrape the material from the coated surface.
